(19) United States
(12) Patent Application Publication
(10) Pub. No.: US 2010/0005665 A1
(43) Pub. Date: Jan. 14, 2010

(54) Craft knife with automatic light

(76) Inventors: Victoria Jean Elliott, Indianapolis, IN (US); Terry Lyle Flynn, Indianapolis, IN (US)

Correspondence Address: TAFT STETTINIUS & HOLLISTER LLP, ONE INDIANA SQUARE, SUITE 3500, INDIANAPOLIS, IN, 46204, US

(21) Appl. No.: 12/459,649

(22) Filed: Jul. 6, 2009

Related U.S. Application Data
(60) Provisional application No. 61/133,856, filed on Jul. 3, 2008.

(51) Int. Cl. B26B 11/00

(52) U.S. Cl. 30/123

(57) ABSTRACT

A craft knife has an automatic light and is constructed of two electrically conductive cylindrical handle parts insulated from each other by a dielectric possessing on one end a clear blade/tool clamping collet with the capacity to transmit light from its base or threaded end, to its spherical end and thus illuminate the blade, blade tip and work area.

### CROSS-REFERENCE TO RELATED APPLICATIONS

Claiming benefit of provisional patent application No. 61/133,856 filed Jul. 3, 2008

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention is in the field of hobby/crafts/commercial artsistry. More particularly, the present invention is in the technical field of precision cutting by hand and precision cutting artistry.

Conventional craft knives force the user to rely on ambient light or added peripheral artificial light to illuminate his work piece. This type of knife produces unavoidable shadows, both from the knife itself, and from the users hand. Additionally, there are people who often have degraded eyesight due to age or other eye or vision difficulties. Those persons need more light on their subject matter than is conventionally feasible. Also, accurate or precise cutting is, at best, difficult in low light surroundings.

One prior art solution to this problem is a tool that generates it's own light, instead of using external lighting. One example of this solution is disclosed in U.S. Pat. No. 6,030,092. While it does have the advantage of directing light at the area where the user is performing the work, it does not however allow for precision cutting. It relies more on the dexterity of the users wrist rather than the greater dexterity allowed by a persons fingers.

### BRIEF SUMMARY OF THE INVENTION

The present invention is a craft knife that automatically illuminates the blade and blade tip as well as a section of the work or material being cut.

### BRIEF DESCRIPTION OF THE SEVERAL VIEWS OF THE DRAWING

FIG. 1 is a perspective view of a craft knife with automatic light in use;

FIG. 2 is a side view of a craft knife with an automatic light;

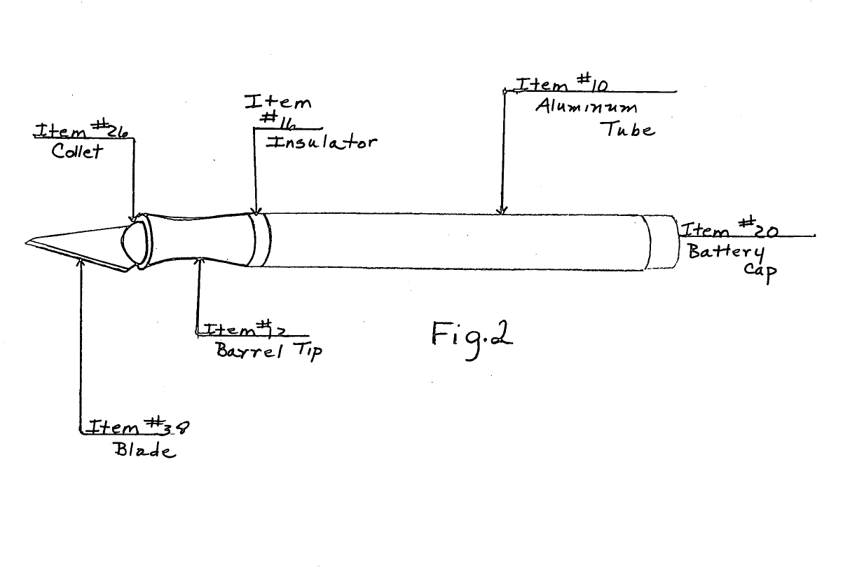

FIG. 3 is a cross sectional view of the craft knife with automatic light;

FIG. 4 is an exploded view of the craft knife with automatic light;

FIG. 5 is a perspective view of the blade holder (collet)

FIG. 6 is a perspective view of an alternative blade holder (collet);

FIG. 7 is a schematic of the electronic switching circuit;

### DETAILED DESCRIPTION OF THE INVENTION

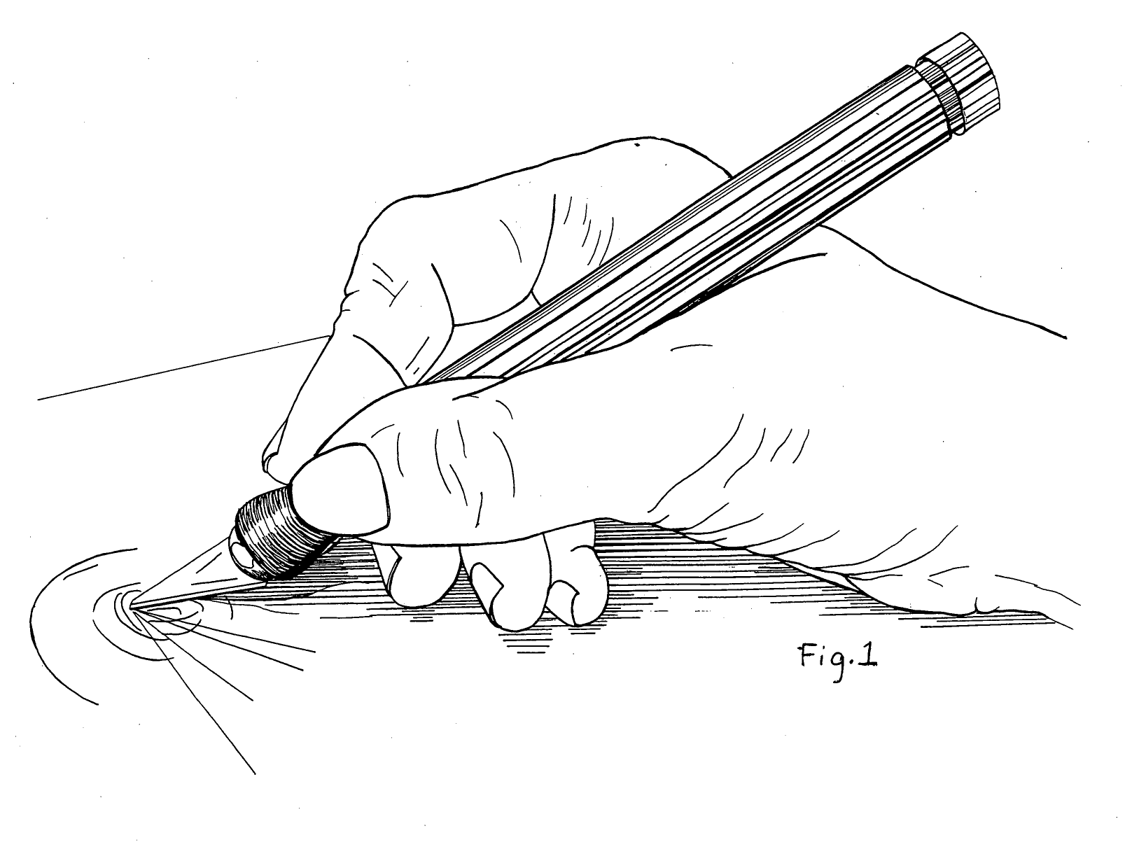

Referring now to the invention in more detail, FIG. 1 is a craft knife with automatic light being held in a users hand. The craft knife with automatic light is of a comfortable length, weight and diameter, with a barrel tip (item 12) being contoured for additional comfort to the thumb and first finger of the user. It features standard replaceable blades, readily available in a plurality of geometries, as well as a replaceable battery. The integrated light automatically turns on when the user is holding the craft knife with automatic light in his hand, and automatically turns off when the user lays it down.

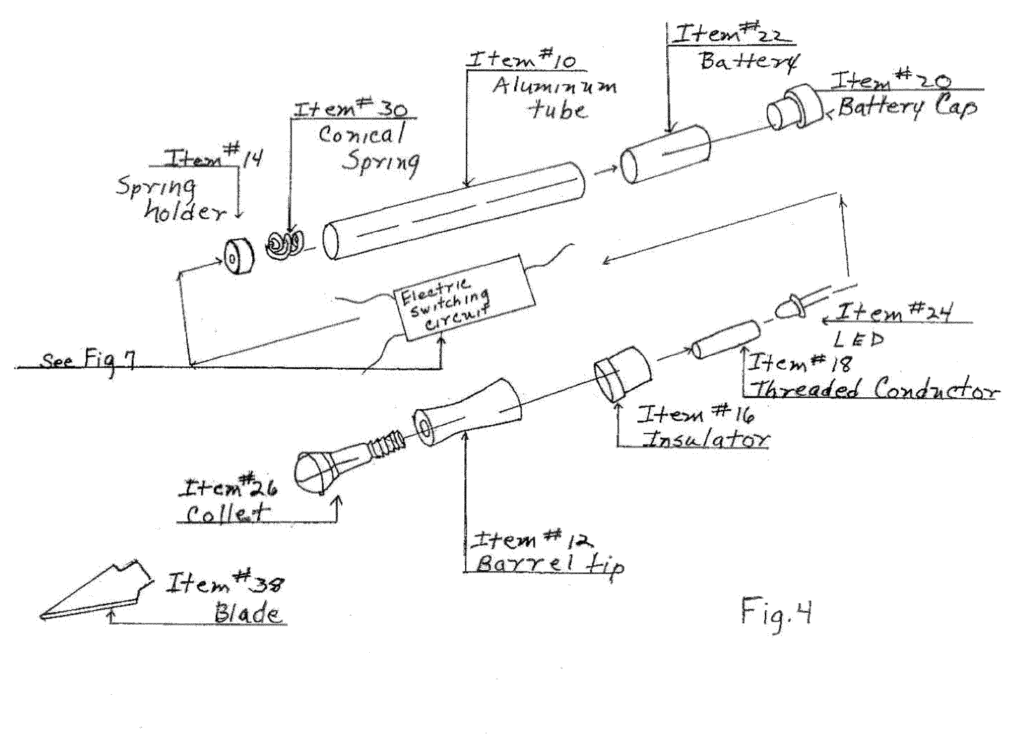

In further detail, FIG. 4 there is shown an aluminum tube (item 10). Located within this aluminum tube (item 10) is a battery spring holder (item 14) comprised of a non electrically conductive material possibly plastic, pvc or other solid but readily machinable material which resists electrical conduction. The battery spring holder (item 14) is cylindrical in shape, having a length approximately equal to its diameter, possessing a recess on one end. This recess is of a diameter to accommodate the larger end of a conical spring (item 30) and has a depth suitable to disallow said spring to move laterally, preventing an electrical short or electrical current to flow between the conical spring (item 30) and the aluminum tube (item 10). Additionally, the battery spring holder (item 30) has a centered through hole extending from one end to the other. This hole is of a sufficient diameter to allow an insulated wire of at least 28 gauge to pass through it unobstructed.

In further detail, FIG. 4 there is shown an aluminum battery cap (item 20) basically cylindrical in shape. Approximately one half of the battery cap (item 20) has a diameter approximately equal to the outside diameter of the aluminum tube (item 10), the other approximately one half of the battery cap (item 20) has a diameter approximately equal to the inside diameter of the aluminum tube (item 10). The length of the battery cap (item 20) is approximately twice that required for a person of normal hand size to comfortably grip and remove it, allowing access to, and the occasional replacement of, the battery (item 22). The battery cap (item 20) attaches to the aluminum tube (item 10) with matching machined threads, a firm slip fit, or bayonet style of push and turn.

In further detail, FIG. 4 shows a battery (item 22). The battery (item 22) basically cylindrical in shape, has a diameter less than the inside diameter of the aluminum tube (item 10), and a length that is not obsessive relative to the remaining space in the aluminum tube (item 10). The battery (item 22) has a voltage rating sufficient to cause approximately 10-30 microamps to flow through normal, unconditioned human skin or tissue.

In yet further detail, FIG. 4 shows an insulator (item 16), made of plastic, pvc or other firm yet machinable material with electrically non conductive properties. The insulator (item 16) also has a shape approximating a cylinder but with two different diameters. The major diameter of the insulator (item 16) has a dimension approximately equal to the outside diameter of the aluminum tube (item 10). The minor diameter of the insulator (item 16) is approximately equal to the inside diameter of the aluminum tube (item 10). The insulator (item 16) also has a centered through hole extending from one end of the insulator (item 16) to the other. This hole is of a sufficient diameter to allow insertion of the threaded conductor (item 18).

In yet further detail, FIG. 4 there is shown a threaded conductor (item 18) manufactured from aluminum or other material that is firm and readily electrically conductive. The threaded conductor (item 18) is cylindrical in shape having a through hole drilled and tapped with a common thread size through its length. Its length is approximately twice the length of the insulator (item 16). The outside diameter of the threaded conductor (item 18) is approximately two thirds the inside diameter of the aluminum tube (item 10). The internal geometry of the threaded conductor (item 18) matches and mates to the threaded portion of the collet (item 26).

In continuing detail, FIG. 4 there is shown a barrel tip (item 12) machined from aluminum or other material that is firm and readily electrically conductive. This barrel tip (item 12) may possesses (as shown) an hourglass shape but also may be cylindrical or other shape to allow additional comfort to the user. It has a through hole centered on the barrel tip's (item 12) diameter from end to end, of which most of its diameter is very close to, but slightly larger than the outside dimension of the threaded conductor (item 18). The balance of the through hole is tapered approximately 10 degrees. This taper matches the taper of the collet (item 26). The minor diameter of the taper being slightly larger than, the outside diameter of of the threaded conductor (item 18) and the major diameter matching the major spherical diameter of the collet (item 26).

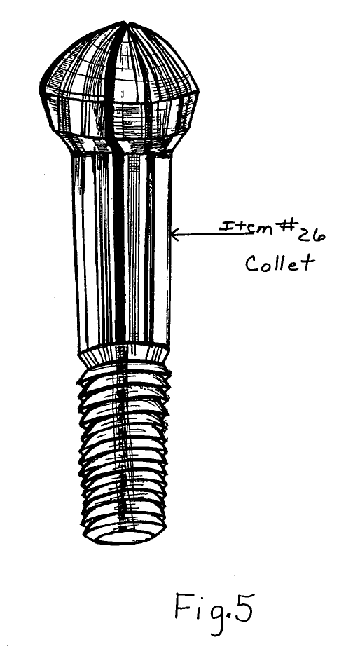

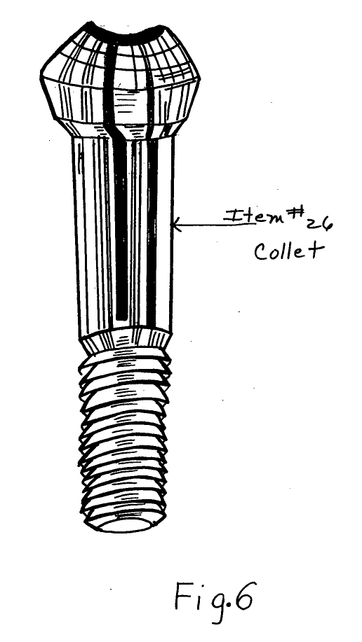

In further detail, FIG. 4 there is shown a collet (item 26) machined from acrylic plastic FIG. 5, petg plastic or any light conducting material flexible enough to adequately grip the blade (item 38). Approximately half of its length is threaded to match and mate to the threaded conductor (item 18). The balance of its length is made up of an unthreaded shaft and a hemisphere whose major diameter is approximately equal to the major inside diameter of the barrel tip (item 12). The collet (item 26) also features a taper of approximately 10 degrees between its spherical end and the unthreaded portion of its shaft. This taper matches and mates to the internal taper of the barrel tip (item 12). The collet also has a sawn slit centered and extending lengthwise through half of its length. This slit is of similar dimension to the thickness of the blade (item 38). As an alternative to being made of a light conducting material, the collet (item 26) might also be made from aluminum or some other non light conducting material, but possess a centered through hole from one end to the other. See FIG. 6.

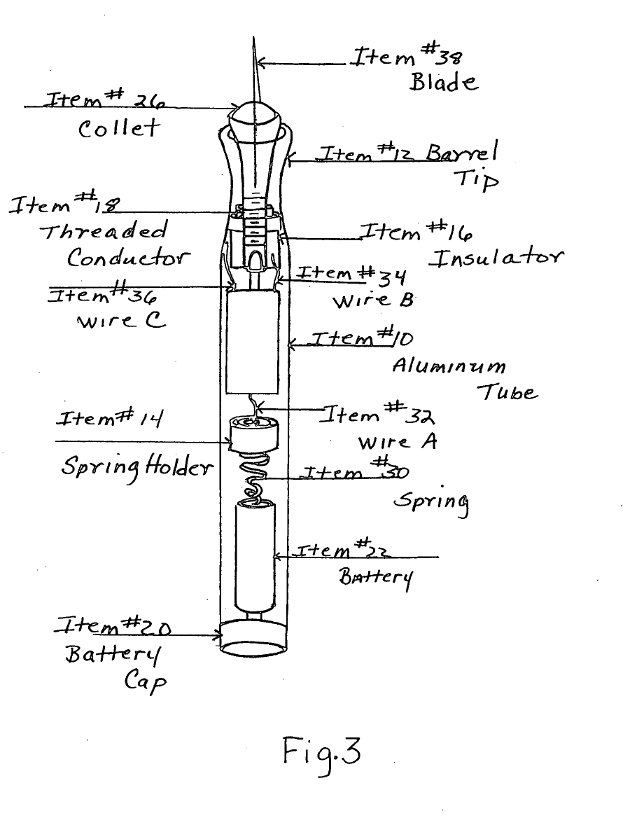

### Details of Mechanical Construction FIG. 3

The battery spring holder (item 14) is located inside the aluminum tube (item 10), with its recessed end facing the battery cap (item 20) and at a distance from the installed battery cap (item 20) approximately equal to: the overall length of the battery (item 22) plus one half the compressed height of conical spring (item 30). The battery spring holder (item 14) is to be held in its position by adhesive, mechanical crimp, pressed fit, or other means that would reliably hold the battery spring holder (item 14) in its proper position inside the aluminum tube (item 10).

Wire A (item 32) is a length of insulated stranded conductor approximately 20 gauge with a portion of the insulation removed from each end. One end electrically and mechanically attaches to the conical spring (item 30) by soldering or crimping. The other end is threaded through the through hole of the battery spring holder (item 14) such that the major diameter of the conical spring (item 30) sits in the recessed area of the battery spring holder (item 14). The major diameter of the conical spring (item 30) attaches to the recessed area of the battery spring holder (item 14) by adhesive or pressed fit. After passing through the battery spring holder (item 14), wire A (item 32) electrically and mechanically attaches to the electronic switching circuit via solder or crimp. (See Electronic switching circuit below)

The battery cap (item 20) is assembled to the aluminum tube (item 10) by either matching machined threads, allowing it to be screwed into the aluminum tube (item 10), or by a pressed fit, push in and turn style of bayonet or other means which would reliably hold the battery cap (item 20) in its proper position in the end of the aluminum tube (item 10)

The threaded conductor (item 18) is positioned in the through hole of the insulator (item 16) with only a small portion of its length extending from the minor diameter of the insulator (item 16), and a significantly longer portion of the threaded conductor (item 18) extending out from the end of the major diameter of the insulator (item 16). The threaded conductor (item 18) is held in position by press fit, adhesive, crimp or other means which would reliably hold it in its proper position inside the insulator (item 16).

The light emitting diode (item 24) electrically and mechanically attached to the electronic circuit (see electronic switching circuit below), is placed into the threaded conductor (item 18), as it slightly protrudes from the end of the minor diameter of the insulator (item 16), spherical end first, and held there by pressed fit or adhesive.

Wire B (item 34) is a length of insulated stranded conductor approximately 20 gauge with a portion of the insulation removed from each end. One end of wire B (item 34) electrically and mechanically attaches to the outside diameter of the threaded conductor (item 18) as it protrudes from the minor diameter of the insulator (item 16) by soldering, crimping or other reliable means of electrical connection The other end is electrically and mechanically soldered or crimped to the electronic switching circuit creating a reliable electrical connection. (See Electronic switching circuit below)

As a unit, the insulator (item 16), threaded conductor (item 18) the light emitting diode (item 24) and the attached electronic switching circuit are now placed inside the opposite end of the aluminum tube (item 10) from the battery cap (item 20). The minor diameter of the insulator (item 16) is secured by either pressed fit and/or adhesive into the inside diameter of the aluminum tube (item 10) opposite the battery cap (item 20) end.

Wire C (item 36) is a length of insulated stranded conductor approximately 20 gauge with a portion of the insulation removed from each end. One end electrically and mechanically attaches to the aluminum tube (item 10) by soldering, crimping or other means that is reliable both mechanically and electrically. The other end electrically and mechanically attaches to the electronic circuit by means of soldering or crimping. (See Electronic switching circuit below)

The non-tapered end of the barrel tip (item 12) is placed on the protruding portion of the threaded conductor (item 18) in a slip fit, securing a good electrical connection between the barrel tip (item 12) and the threaded conductor (item 18).

The collet (item 26) is placed threaded end first into the barrel tip (item 12) engaging the threads on its outside diameter with the threads in the inside diameter of the threaded conductor (item 18). The collet (item 26) is now rotated so as to thread itself into the threaded conductor (item 18). This simultaneously pulls the collet (item 26) with its taper, into the mating taper of the barrel tip (item 12). The blade (item 38) is now inserted into the slit of the collet (item 26). Resume rotating the collet (item 26). As the collet (item 26) taper engages the taper in the barrel tip (item 12), the collet (item 26) is under compression. This squeezing force is transferred through the collet (item 26) to the blade (item 38), holding it firmly in position.

The battery cap (item 20) is removed, and the battery (item 22) is placed inside the aluminum tube (item 10) negative end first. The battery cap (item 20) is then placed back in its position in the end of the aluminum tube (item 10).

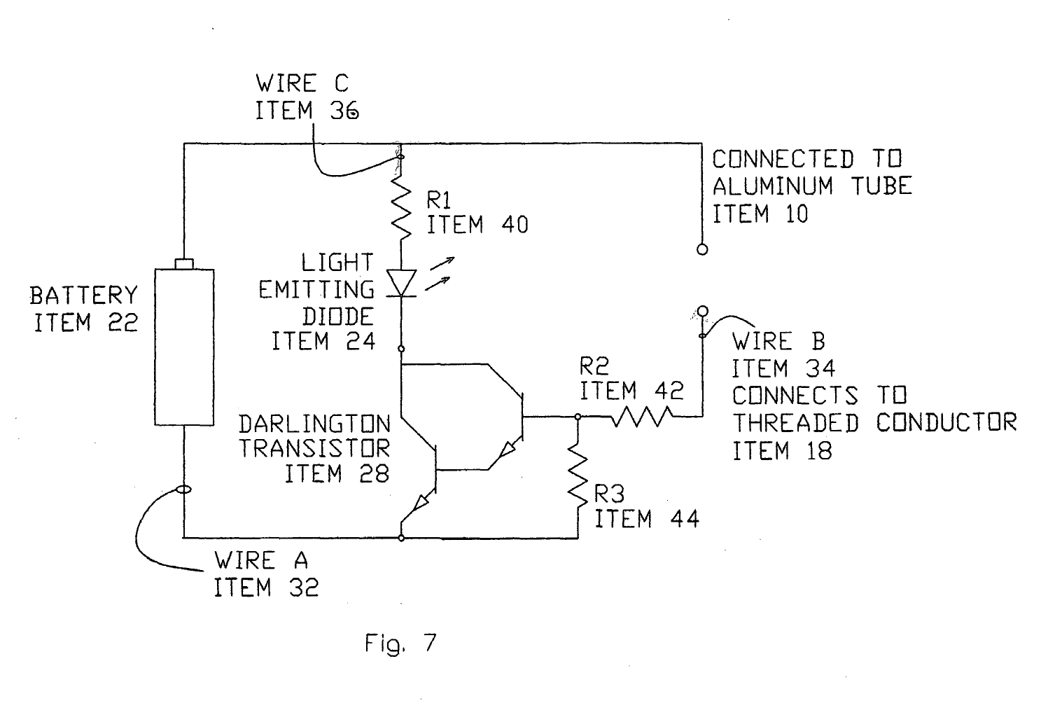

### Electronic Switching Circuit FIG. 3 and FIG. 7

The electronic switching circuit consists of a darlington transistor (item 28) FIG. 7, and three resistors, R1 (item 40) FIG. 7, R2 (item 42) FIG. 7, R3 (item 44) FIG. 7. Its function is to detect a person's hand touching both the barrel tip (item 12) FIG. 3 and the aluminum tube (item 10) FIG. 3 simultaneously, and turn on the light emitting diode (item 24) FIG. 3 and FIG. 7. The light from the light emitting diode (item 24) FIG. 3 is trained on the threaded end of the collet, (item 26) FIG. 3 which is clear and readily conducts light to its spherical end, illuminating the blade (item 38) FIG. 3 edge, the blade tip (item 38) FIG. 3, and a section of the work area.

The battery cap (item 20) FIG. 3 contacts the positive end of the battery (Item 22) FIG. 3, and the aluminum tube (item 10) FIG. 3. This gives both the battery cap (item 20) FIG. 3 and the aluminum tube (item 10) FIG. 3 the same voltage potential as the positive end of the battery (item 22) FIG. 3 and FIG. 7. When a user holds the craft knife with automatic light, his hand naturally comes into contact with both the aluminum tube (item 10) FIG. 3 and the barrel tip (item 12) FIG. 3. A very slight electrical current will flow from the aluminum tube (item 10) FIG. 3 through his hand and into the barrel tip (item 12) FIG. 3, into the threaded conductor, through wire A (item 32) FIG. 3 and FIG. 7, to R1 (FIG. 7), through R1 FIG. 7 to the BASE terminal of the darlington transistor (item 28) FIG. 7, causing the darlington transistor (item 28) FIG. 7 to start conducting current from the positive side of the battery (item 22) FIG. 3 and FIG. 7, through current limiting resistor R2 (item 42) FIG. 7, through the light emitting diode (item 24) FIG. 3 and FIG. 7, through the darlington transistor (item 28) FIG. 7, to the negative terminal of the battery (item 22) FIG. 3 and FIG. 7. Resistor R1 (item 40) FIG. 7 also protects the darlington transistor (item 28) FIG. 7 against potential short circuits that could occur if the craft knife with automatic light were to placed on a metal or other highly conductive surface. R2 (item 42) FIG. 7 keeps the current flow through the light emitting diode (item 24) FIG. 3 and FIG. 7 to a level below its maximum rating. R3 (item 44) FIG. 7 simply bleeds any unwanted signals to the negative terminal of the battery (item 22) FIG. 7, that might falsely gate the darlington transistor (item 28) FIG. 7 and illuminate the light emitting diode (item 24) FIG. 3 and FIG. 7.

The craft knife with automatic light as shown is made primarily from aluminum, type 1 pvc, and acrylic, however there are many other materials that would lend themselves well to it's construction. As an example, there are many different types of aluminum and similar metals that would perform equally well in this application. Also, there is a host of different plastics and other strong materials of high dielectric strength that could be used for pieces that require electrical insulation. The collet in particular, could be made of a wide variety of materials that are clear and light conductive in nature. In addition, the electronic circuit might use completely different components, a brighter light emitting diode perhaps, or even a capacitive type of switching circuit instead of the one depicted here. Substituting just a few components could dramatically change the applications for which it is intended. For instance, a different type of tool tip and collet, and the craft knife with automatic light could be a medical knife or tool, a dental tool, a glass cutter or a host of other, as of yet, not commercially available tools and products.

The advantages of the present invention include, without limitation, considerably increased visual perception of the work. There is no manual switch to be actuated by the user. The battery life is considerable and predictable. It has a comfortable and user friendly contour. The user does not have to be concerned with turning it on and off.

It is to be understood, however, that even though numerous characteristics and advantages of the present invention have been set forth in the foregoing description, together with details of structure and function of the invention, the disclosure is illustrative only, and changes may be made in detail, especially in matters of shape, size and arrangement of parts within the principles of the invention to the full extent indicated by the broad meaning of the terms in which the appended claims are expressed.

The embodiments of the invention in which an exclusive property or privilege is claimed are defined as follows:

1. A craft knife with an automatic light constructed of two electrically conductive cylindrical handle parts insulated from each other by a dielectric possessing on one end a clear blade/tool clamping collet, or a blade/tool clamping collet that possesses a hole drilled entirely through its length, with the capacity to transmit light from it's base or threaded end, to it's spherical end and thus, illuminate the blade, blade tip and work area. The blade is specifically not claimed as part of the invention.

2. An electronic circuit that resides inside the cylindrical handle consisting of a suitable lamp, power supply and switching circuit that, detects even slight electrical conductivity or capacitance and simultaneously powers the lamp, whose visible light is trained on the base or threaded end of the collet described in claim 1.
